(19) United States
(12) Patent Application Publication
(10) Pub. No.: US 2004/0142835 A1
(43) Pub. Date: Jul. 22, 2004

(54) Washing liquid for semiconductor substrate

(75) Inventor: Masayuki Takashima, Sodegaura-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Sumitomo Chemical Company, Limited

(21) Appl. No.: 10/702,621

(22) Filed: Nov. 6, 2003

(30) Foreign Application Priority Data
Nov. 8, 2002 (JP) 2002-324986
Aug. 29, 2003 (JP) 2003-209669

(51) Int. Cl. C11D 1/00

(52) U.S. Cl. 510/175

(57) ABSTRACT

The present invention provides a washing liquid for a semiconductor substrate having a pH of 6 to 12 and comprising a chelating agent and a chelate accelerating agent.

### FIELD OF THE INVENTION

The present invention relates to a washing liquid for a semiconductor substrate.

### BACKGROUND OF THE INVENTION

Techniques for washing the surface of a semiconductor substrate in manufacturing a semiconductor device have been increasingly significant with realizing fineness and high-speed performance of the device. A diameter of a silicon wafer used as a substrate has been progressively increased in order to improve the yield of adevice, and a silicon oxide film, a silicon nitride film, and the like in addition to silicon film, have been used as materials for composing an element of a semiconductor device formed on the wafer, and additionally in recent years a new metal film, such as cobalt film, and tungsten film, has beenintheprogressofusingfortheelement. Ithasbeendesired to develop such washing liquid that impurities adhering onto a wafer surface can be efficiently removed without doing damage to such materials, which have been used in recent years, for composing an element of a semiconductor device.

A mixed solution of ammonia water, hydrogen peroxide and water, or a mixed solution of hydrochloric acid, hydrogen peroxide and water, has been conventionally used as a washing liquid for a substrate wafer, and these solutions have been heated at a temperature of 40 to 80° C., whereby fine particles and metallic impurities have been removed (JP No.09-040997 A). In the case where such a method is applied to a large-diameter wafer, however, energy efficiency is low, and manufacturing equipments is corroded by vapor caused by heating.

As an improvement for washing liquid, a washing liquid being pH 1 and usable at the normal temperature has been proposed such that a slight quantity of ammonia or ethylenediaminetetraacetic acid (a chelating agent) as an alkaline component is contained in an acidic aqueous solution such as hydrofluoric acid (JP No.07-094458 A). However, such an acidic washing liquid etches a silicon oxide film, and a metal film, such as tungsten film, and thereby the damage such as corrosion is done thereto.

The present invention provides such a washing liquid for a semiconductor substrate being usable at the room temperature, as can sufficiently suppress etching on a silicon oxide film, and a metal film, such like tungsten film, while the washing liquid has a great ability to rinse particulate foreign materials and, ionic foreign materials on a semiconductor substrate.

### SUMMARY OF THE INVENTION

Through earnest studies for finding out a washing liquid for a semiconductor substrate, the inventors of the present invention have completed the present invention by finding out that a washing liquid comprising a chelating agent and a chelate accelerating agent and having a pH of 6 to 12 can greatly control etching on a silicon oxide film, and a metal film, such as tungsten film, while such washing liquid has a great ability to rinse metallic ions and metallic impurities on the surface of a semiconductor substrate when used at the room temperature.

That is, the present invention provides a washing liquid for a semiconductor substrate comprising a chelating agent and a chelate accelerating agent, and having a pH of 6 to 12;

Also the present invention provides a method of washing a semiconductor substrate comprising the step of washing a semiconductor substrate with the washing liquid

### BRIEF DESCRIPTION OF THE DRAWING

FIG. 1 shows an example of a constitution of a washing equipment for washing a semiconductor substrate, which circulatingly uses a washing liquid employed in the examples.

### DETAILED DESCRIPTION OF PREFERRED EMBODIMENTS

A washing liquid for a semiconductor substrate of the present invention comprises a chelating agent and a chelate accelerating agent.

The chelating agent includes at least one of chelating agent selected from the group consisting of heterocyclic compounds having at least one of a hydroxyl group and a carboxyl group, polyaminocarboxylic acids and a salt thereof, polycarboxylic acids and a salt thereof, compounds having a phosphonic group and a salt thereof, oxycarboxylic acids and a salt thereof, phenols and tropolones.

The example of the polyaminocarboxylic acids and a salt thereof includes ethylenediaminetetraacetic acid (EDTA), trans-1,2-cyclohexanediaminetetraacetic acid (CyDTA), nitrilotriacetic acid (NTA), diethylenetriaminepentaacetic acid (DTPA), N-(2-hydroxyethyl)ethylenediamine-N,N′,N′-triacetic acid (EDTA-OH), and a salt of these compounds.

The salt of these compounds includes an ammonium salt, a sodium salt, a potassium salt and the like.

Among these, ethylenediaminetetraacetic acid (EDTA) and an ammonium salt thereof are preferable.

The example of polycarboxylic acids and a salt thereof includes oxalic acid, malonic acid, succinic acid, glutaric acid, methylmalonic acid, 2-carboxybutyric acid, and a salt of these compounds.

The salt of these compounds includes an ammonium salt, a sodium salt, a potassium salt and the like.

Among these, oxalic acid and an ammonium salt thereof are preferable.

The example of compounds having a phosphonic group and a salt thereof includes ethylenediamine tetramethylenephosphonic acid, ethylenediaminedimethylenephosphonic acid, nitrilotrismethylenephosphonic acid, 1-hydroxyethylidene-1,1-diphosphonic acid, and a salt of these compounds.

The salt of compounds having a phosphonic group includes an ammonium salt, a sodium salt, a potassium salt and the like of the above-mentioned acids.

Among these, 1-hydroxyethylidenediphosphonic acid and an ammonium salt thereof are preferable.

The example of oxycarboxylic acids and a salt thereof includes gluconic acid, tartaric acid, citric acid, and a salt of these compounds.

The salt of these compounds includes an ammonium salt, a sodium salt, a potassium salt and the like.

Among these, citric acid and an ammonium salt thereof are preferable.

The example of phenols includes phenol, cresol, ethylphenol, tert-butylphenol, methoxyphenol, catechol, resorcinol, hydroquinone, 4-methylpyrocatechol, 2-methyl hydroquinone, pyrogallol, 3,4-dihydroxybenzoic acid, gallic acid, 2,3,4-trihydroxybenzoic acid, 2,4-dihydroxy-6-methylbenzoic acid, ethylenediaminediorthohydroxyphenylacetic acid [EDDHA], N,N-bis(2-hydroxybenzyl)ethylenediamine-N,N-diacetic acid [HBED], ethylenediaminedihydroxymethylphenylacetic acid [EDDHMA], and the like; among these, catechol is preferable.

The example of heterocyclic compounds having at least one of a hydroxyl group and a carboxyl group includes 8-quinolinol, 2-methyl-8-quinolinol, quinolinediol, 1-(2-pyridylazo)-2-naphthol, 2-amino-4,6,7-pteridinetriol, 5,7,3′,4′-tetrahydroxyflavone [luteolin], 3,3′-bis [N,N-bis(carboxymethyl)aminomethyl]fluorescein [calcein], 2,3-hydroxypyridine, and the like; among these, 8-quinolinol is preferable.

The example of tropolones includes tropolone, 6-isopropyl tropolone, and the like; among these, tropolone is preferable.

The content of a chelating agent in a washing liquid of the present invention is typically 0.00001 to 10 weight %, preferably 0.0001 to 1 weight %. When the content is less than 0.00001 weight %, an ability to rinse mental of a chelating agent may not be sufficient, while a content is more than 10 weight %, solubility of a chelating agent in a washing liquid may be over its saturation solubility.

The chelate accelerating agent used for the present invention is not particularly limited if it improves the ability to rinse metal of a chelating agent; and includes, for example, a fluoride or a salt thereof, a compound having a hydroxyl group, both of a fluoride or a salt thereof and a compound having a hydroxyl group.

Among these, from the viewpoint of improying the effect of accelerating chelation of metallic impurities adhering onto the surface of a semiconductor substrate, a compound comprising both of a fluoride or a salt thereof and a compound having a hydroxyl group is preferable.

The example of, the fluoride or a salt thereof includes hydrofluoric acid, potassium fluoride, sodium fluoride, ammonium fluoride, and the like. Among these, ammonium fluoride is preferable.

The example of compound having a hydroxyl group includes an inorganic compound, a hydroxide such as quaternary ammonium, and alkanolamines; specifically, an inorganic compound such as sodium hydroxide, potassium hydroxide and ammonium hydroxide, quaternary ammonium such as tetramethylammonium hydroxide and trimethyl(2-hydroxy)ethylammonium hydroxide, and alkanolamines such as monoethanolamine, diethanolamine, triethanolamine, 2-methylaminoethanol, 2-ethylaminoethanol, N-methyldiethanolamine, dimethylaminoethanol, 2-(2-aminoethoxy)ethanol, 1-amino-2-propanol, monopropanolamine and dibutanolamine.

Among these, from the viewpoint of not contaminating metal on the surface of a semiconductor substrate, ammonium hydroxide and tetramethylammonium hydroxide are preferable.

A washing liquid of the present invention typically contains 0.0001 to 40 weight % of a chelate accelerating agent, preferably 0.001 to 10 weight %, and more preferably 0.1 to 5 weight %.

In the case where a washing liquid of the present invention comprises both of a fluoride or a salt thereof, and a compound having a hydroxyl group as a chelate accelerating agent, any ratio of these compounds is selected from the above-mentioned range for the content thereof; specifically, the content of a compound having a hydroxyl group is typically 0.00005 to 30 weight %, preferably 0.001 to 1 weight %, and the content of a fluoride or a salt thereof is typically 0.00005 to 40 weight %, preferably 0.01 to 5 weight %.

With regard to a compound having a hydroxyl group in a washing liquid of the present invention, if a concentration is less than 0.00005 weight %, an ability to rinse metal of a washing liquid may not be sufficient, while a concentration is more than 30 weight %, the surface of a semiconductor substrate such as silicon may be roughed. Also, with regard to a fluoride or a salt thereof in a washing liquid of the present invention, if a concentration is less than 0.00005 weight %, an ability to rinse metal of a washing liquid may not be sufficient, while a concentration is more than 40 weight %, an ability to rinse metal of a washing liquid may not be improved enough, leading to a conclusion that it is not economical.

In the case where a washing liquid of the present invention contains both of a fluoride or a salt thereof, and a compound having a hydroxyl group as a chelate accelerating agent, among the above-mentioned ranges of the content of the chelate accelerating agent, an optimum quantity such as to be an objective pH of the liquid in a range of pH 6 to 12 is selected for each content of these compounds in a washing liquid of the present invention.

In the case of containing ammonium hydroxide as a compound having a hydroxyl group and ammonium fluoride as a fluoride or a salt thereof, the content of ammonium fluoride is preferably selected from a range of 0.015 to 0.45 weight % with respect to a content of 0.015 weight % as to ammonium hydroxide.

A washing liquid of the present invention is neutral to alkaline ranging from pH 6 to 12.

A washing liquid of the present invention not only rinses metallic ions and metallic impurities on a semiconductor substrate but also has a performance such as to less do etching damage to a semiconductor element on a substrate, and then the above-mentioned pH range is important for satisfying such a performance. If a pH is less than this range, the acidic liquid may etch a metal film, and a silicon oxide film, composing a semiconductor element, while a pH is more than this range, a washing liquid may etch silicon itself of a substrate.

In order to make a washing liquid of the present invention into neutrality to alkalinity ranging from pH 6 to 12, it is preferred that a proper concentration is selected from the concentration range of each component described above to adjust so as to be an optimum pH.

A washing liquid of the present invention may further comprise a pH buffering agent if necessary.

A salt of a compound not including metal is preferable as the pH buffering agent contained in a washing liquid of the present invention. The example includes ammonium hydrogen phthalate, ammonium dihydrogen citrate, ammonium chloride, ammonium citrate, ammonium carbonate, ammonium hydrogen carbonate, ammonium acetate, and the like; among these, ammonium carbonate, ammonium hydrogen carbonate and the like are more preferable.

In the case where a washing liquid of the present invention contains a pH buffering agent, 0.01 to 10 weight % of the pH buffering agent is usually contained in a washing liquid of the present invention, preferably 0.1 to 5 weight %.

A pH buffering agent has a function of stabilizing the pH of the liquid and is contained in a washing liquid of the present invention, whereby the pH thereof can be stabilized when circulatingly using a washing liquid of the present invention.

On the occasion of circulatingly using a washing liquid of the present invention, with regard to a pH buffering agent in a washing liquid of the present invention, when a content is less than 0.01 weight %, the stabilization of the pH of the liquid may be insufficient, while a content is more than 10 weight %, the solubility of a pH buffering agent therein may be over its saturation solubility, and additionally an undissolved component may adhere onto the washed surface of a semiconductor substrate to thereby contaminate the substrate.

In the case where a washing liquid of the present invention contains a pH buffering agent, a range in which the pH thereof is stabilized is determined by a combination of a compound having a hydroxyl group in a washing liquid and a pH buffering agent; for example, in the case of using ammonium hydroxide as a compound having a hydroxyl group and ammonium carbonate as a pH buffering agent, the pH is stabilized in a range of 7.0 to 8.5, and also in the case of using ammonium hydroxide and ammonium chloride instead of ammonium carbonate as a pH buffering agent, the pH is stabilized in a range of 8.0 to 11.0.

A washing liquid of the present invention may contain a surfactant.

On that occasion, the surfactant contained in a washing liquid of the present invention includes, for example, a surfactant represented in the following formula I

HO—((EO)ₓ—(PO)_{y})—H (I),

wherein EO denotes an oxyethylene group, PO denotes an oxypropylene group, x and y denote a positive number satisfying x/(x+y)=0.05 to 0.4, and z denotes a positive integer, and a surfactant represented in the following formula II,

R—[((EO)ₓ—(PO)_{y})_{z}—H]ₘ (II)

Wherein EO denotes an oxyethylene group, PO denotes an oxypropylene group, x and y denote a positive number satisfying x/(x+y)=0.05 to 0.4, z denotes a positive integer, R denotes a group represented in R¹—O—, H₂N—R²—NH— and H₂N—R³—O—, a group represented in H₂N—R²—N<, —HN—R³—O— and —NH—R³—NH—, a group represented in —HN—R²—N< and >N—R³—O—, or a group represented in >N—R²—N<, and m denotes an integer of 1 to 4 corresponding to a valence number of R. R¹ denotes an alkyl group with a carbon number of 1 to 20, and R² and R³ denote each independently an alkylene group with a carbon number of 1 to 10.

In a compound represented in the above-mentioned formulae I and II, EO denotes an oxyethylene group [—CH₂—CH₂—O—], and PO denotes an oxypropylene group [—CH(CH₃)—CH₂—O-] or [—CH₂—CH(CH₃)—O—].

x and y denote a positive number by which x/(x+y) satisfies 0.05 to 0.4.

If a value is less than 0.05 of x/(x+y), the solubility of a surfactant may be insufficient when adjusting a washing liquid, while a value more than 0.4 of x/(x+y), defoaming property of the liquid may not be sufficient.

In the general formulae (I) and (II), a unit represented in ((EO)ₓ—(PO)_{y}) may be a block copolymer, a random copolymer or a random copolymer assuming blocking property. Among these, a block copolymer is preferable.

In the formula (II), R denotes a group represented in R¹—O—, H₂N—R²—NH— and H₂N—R³—O—, a group represented in H₂N—R²—N<, —HN—R³—O— and —NH—R³—NH—, a group represented in —HN—R²—N<and >N—R³—O—, or a group represented in >N—R²—N<, and m denotes an integer of 1 to 4 corresponding to a valence number of R. R¹ denotes an alkyl group with a carbon number of 1 to 20, and R² and R³ denote each independently an alkylene group with a carbon number of 1 to 10.

R¹—O— is the residue of a hydroxyl group of R¹—OH from which a hydrogen atom is removed; R¹—OH includes monohydric alcohol such as 2-ethylhexyl alcohol, cetyl alcohol, oleyl alcohol, lauryl alcohol, tridecyl alcohol, tallow alcohol and coconut oil alcohol, dihydric alcohol such as ethylene glycol, propylene glycol, 1,3-propanediol, 1,2-butanediol, 1,3-butanediol, 2,3-butanediol, 1,4-butanediol, 2-methyl-1,2-propanediol and 2-methyl-1,3-propanediol, trihydric alcohol such as glycerin, trimethylolethane and trimethylolpropane, tetrahydric alcohol such as pentaerythritol and sorbitol, and the like.

H₂N—R²—NH—, H₂N—R²—N<, —NH—R³—NH—, —HN—R²—N< and >N—R²—N< are the residue of an amine of H₂N—R²—NH₂ from which a hydrogen atom is removed; H₂N—R²—NH₂ includes ethylenediamine, propylenediamine, and the like.

H₂N—R³—O—, —HN—R³—O— and >N—R³—O— are the residue of H₂N—R³—OH from which a hydrogen atom is removed; H₂N—R³—OH includes monoethanolamine, diethanolamine, triethanolamine, 2-methyl aminoethanol, 2-ethylaminoethanol, N-methyldiethanolamine, dimethylaminoethanol, 2-(2-aminoethoxy)ethanol, 1-amino-2-propanol, monopropanolamine, dibutanolamine, and the like.

In a compound represented in the above-mentioned formulae (I) and (II), the average molecular weight of (PO)_{y} part is preferably 500 to 5000.

A an average molecular weight is less than 500, its effect on washing performance may not be large, while an average molecular weight is more than 5000, the its solubility may be insufficient when preparing.

An example of the formula (I) includes polyoxyethylene polyoxypropyleneglycol, and an example of a compound represented in the formula (II) includes polyoxyethylene polyoxypropylene 2-ethyl hexyl ether, polyoxyethylene polyoxypropylene tridecyl ether, ethylenediamine addition type polyoxyethylene polyoxypropylene glycol, and the like.

A washing liquid of the present invention may contain one or more kinds of these.

In the case where a washing liquid of the present invention contains a surfactant, etching on silicon, polysilicon and the like, is further controlled.

The content of a surfactant is typically 0.0001 to 10 weight % with respect to a washing liquid of the present invention, preferably 0.001 to 0.1 weight %, and more preferably 0.001 to 0.01 weight %.

A concentration of less than 0.0001 weight % may not have an addition effect thereof, while a concentration of more than 10 weight % may bring a great foaming property of a washing liquid, resulting in that handling a washing liquid supplied by a pump and the like may not be easy.

A washing liquid of the present invention may contain both or either of surfactants represented in the formula (I) and the formula (II).

When a washing liquid of the present invention contains a surfactant having a structure represented in the formula (I) or the formula (II), etching damage to a semiconductor substrate, particularly silicon and polysilicon may be further suppressed.

A washing liquid of the present invention may contain other components, for example, various kinds of other surfactant than above such as anionic and cationic, a dispersing agent, an anticorrosive of metal, a hydrogen peroxide water, and the like, within a range of no deterioration in the object of the present invention.

The content of these other components may be 0.01 to 10 weight %, preferably 0.1 to 5 weight %.

A chelating agent, a chelate accelerating agent, as if necessary, a pH buffering agent, a surfactant and other components are added and dissolved in water as a solvent, an organic solvent or a mixture solution thereof, whereby obtaining a washing liquid of the present invention.

The organic solvent used for a washing liquid of the present invention is not particularly limited as long as it can dissolve a chelating agent and a chelate accelerating agent; the example includes (polyhydric) alcohols and a derivative thereof, amides, ketones, esters, and a sulfur-containing compound.

The example of (polyhydric) alcohol and a derivative thereof include tetrahydrofurfuryl alcohol, furfuryl alcohol, propargyl alcohol, diethylene glycol dimethyl ether, diethylene glycol diethyl ether, diethylene glycol monobutyl ether, diethylene glycol monoethyl ether acetate, tetraethylene glycol, triethylene glycol, diethylene glycol, glycerol triacetate, glycerol triglycidyl ether, glycerol diglycidyl ether, ethylene glycol monomethoxymethyl ether, ethylene glycol diglycidyl ether, diethylene glycol ethyl methyl ether, glycerin, dipropylene glycol monomethyl ether, dipropylene glycol, dipropylene glycol monoethyl ether, propylene glycol, and the like; preferably tetrahydrofurfuryl alcohol, diethylene glycol monobutyl ether and diethylene glycol monoethyl ether acetate.

The example of amides includes N-methylpyrrolidone, dimethylacetamide, N,N-dimethylformamide, N-methylformamide, 1,3-dimethyl-2-imidazolidinone, and the like; preferably N,N-dimethylformamide and N-methylpyrrolidone.

The example of ketones includes diacetone alcohol and the like.

The example of esters includes γ-butyrolactone and ethylene carbonate, preferably γ-butyrolactone.

The example of sulfur-containing compound includes dimethyl sulfoxide.

Also, these organic solvents may be used in the mixture of water.

A semiconductor substrate is washed by using a washing liquid of the present invention, whereby metallic ions and metallic impurities on the surface thereof are efficiently rinsed.

The semiconductor substrate for which a washing liquid of the present invention is used includes the surface of a silicon wafer before manufacturing a device as well as an insulator film, such as a silicon oxide film, and a silicon nitride film, thereafter in the process of manufacturing the device, and additionally includes a metal film, such as film, of tungsten, cobalt, copper, aluminum, titanium, titanium nitride, tantalum, ruthenium or hafnium, a low-permittivity insulator film, having a relative permittivity of 3.0 or less, a polysilicon film, an amorphous silicon film, and a substrate having any surface on which materials for composing the device are exposed.

In the case of using a washing liquid of the present invention for washing a semiconductor substrate, the temperature of a washing liquid of the present invention is preferably less than 40° C., more preferably 20° C. to less than 40° C., and in particular preferably 20 to 30° C.

A washing method of the present invention includes a method of washing a semiconductor substrate by using a washing liquid of the present invention; specifically, including an immersion washing method by directly immersing a semiconductor substrate in a washing liquid of the present invention, a method by using ultrasonic irradiation together with the immersion washing method, a spray washing method by spraying a washing liquid of the present invention on the surface of a semiconductor substrate, a brush scrub washing method by washing with a brush while spraying a washing liquid of the present invention, a method by using ultrasonic irradiation together with the brush scrub washing method, and the like.

A washing liquid of the present invention is appropriate for removing metallic ions and metallic impurities adhering onto the surface of a semiconductor substrate such as a silicon wafer.

EXMAPLE

The present invention is further detailed hereinafter by examples, and is not limited thereto.

### Example 1

A washing liquid of the present invention (referred to as Washing Liquid 1) was prepared in accordance with composition and concentration described in Table 1. Also, a washing liquid comprising ammonium hydroxide and hydrofluoric acid (referred to as Comparative Example 1), a washing liquid further comprising ethylenediaminetetraacetic acid as a chelating agent in addition to Comparative Example 1 (referred to as Comparative Example 2), and a washing liquid further comprising 1-hydroxyethylidene-1,1-diphosphonic acid as a chelating agent in addition to Comparative Example 1 (referred to as Comparative Example 3) were prepared as comparison in accordance with concentration described in Table 1. A wafer (referred to as Substrate 1) on whose whole surface silicon previously suffering metal contamination is exposed and a wafer (referred to as Substrate 2) on whose whole surface a silicon oxide film is exposed were immersed in each of the washing liquids prepared above for 5 minutes. Also, the concentration of metallic impurities on a wafer was analyzed by an ICP-MS analyzer before and after being washed. Thereafter, the washing ratio was calculated from the concentration of metallic impurities on a silicon wafer before and after being washed by a manner described below. Also, with regard to Substrate 2, the thickness of the silicon oxide film was measured before and after being washed, whereby the etching rate in each of the washing liquids was compared. The results are shown in Tables 1 and 2.

The concentration of metallic impurities on Substrate 1 before washing was Fe: 28×10¹⁰ atoms/cm², Al: 51×10¹⁰ atoms/cm² and Cu: 72×10¹⁰ atoms/cm², and the concentration of metallic impurities on Substrate 2 before washing was Fe: 300×10¹⁰ atoms/cm², Al: 400×10¹⁰ atoms/cm² and Cu: 160×10¹⁰ atoms/cm².

The calculating manner of the washing ratio was as follows:

washing ratio=(1−the concentration of impurities on a silicon wafer after washing/the concentration of impurities on a silicon wafer before washing)×100

TABLE 1

| | Wash- | Compar- | Compar- | Compar- |
|---|---|---|---|---|
| | ing | ative | ative | ative |
| | Liquid | Example | Example | Example |
| | 1 | 1 | 2 | 3 |
| Ammonium Oxalate | 0.1 | | | |
| (wt %) | | | | |
| HEDP*1 | 0.01 | | | 0.01 |
| (wt %) | | | | |
| Ethylenediaminetetraacetic | | | 0. 01 | |
| Acid (wt %) | | | | |
| Ammonium Hydroxide | 0.015 | 0.01 | 0.01 | 0.01 |
| (wt %) | | | | |
| Hydrofluoric Acid | | 1.0 | 1.0 | 1.0 |
| (wt %) | | | | |
| Ammonium Fluoride | 0.38 | | | |
| (wt %) | | | | |
| Water (wt %) | 99.495 | 98.99 | 98.98 | 98.98 |
| pH of washing liquid | 8.0 | 1.0 | 1.0 | 1.0 |
| Washing Temperature | 25 | 24 | 25 | 25 |
| (° C.) | | | | |

*11-hydroxyethylidene-1,1-diphosphonic acid

TABLE 2
The washing ratio and the etching rate of a silicon
oxide film in each of the washing liquids

| | Washing | Comparative | Comparative | Comparative |
|---|---|---|---|---|
| | Liquid 1 | Example 1 | Example 2 | Example 2 |
| Fe on Substrate 1 | 98 | 99 | 97 | 98 |
| Al on Substrate 1 | 96 | 89 | 96 | 96 |
| Cu on Substrate 1 | 71 | 71 | 75 | 72 |
| Fe on Substrate 2 | 99.5 | 99.7 | 99.8 | 99.8 |
| Al on Substrate 2 | 98 | 99 | 99 | 97 |
| Cu on Substrate 2 | 99.8 | 99.8 | 99.8 | 99.8 |
| Etching Rate of | 1.2 | 140 | 136 | 145 |
| Silicon Oxide | | | | |
| Film (Å/min) | | | | |

It is understood from Table 2 that Washing Liquid 1 has the approximately same ability to rinse metal as Comparative Examples 1, 2 and 3. On the other hand, a silicon oxide film is greatly etched in Comparative Examples 1, 2 and 3, whereas etching is suppressed in Washing Liquid 1. It is therefrom understood that Washing Liquid 1 is preferable also for washing a semiconductor substrate on whose surface a silicon oxide film is exposed in comparison to Comparative Examples 1, 2 and 3.

### Example 2

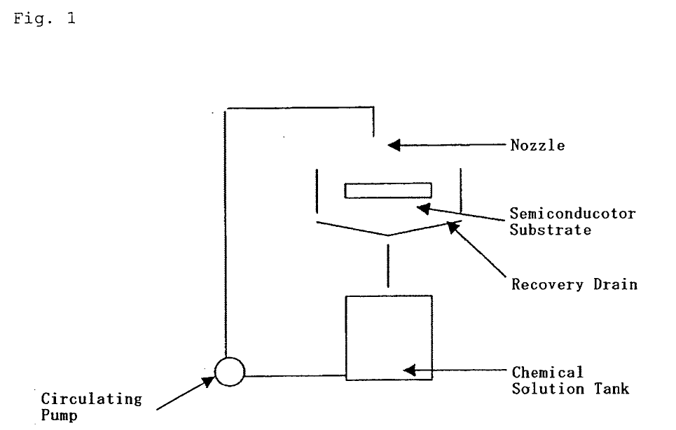

Washing Liquids 2 and 3 were prepared in accordance with composition described in Table 3. The prepared Washing Liquid 2 was accommodated in a chemical solution tank 1 of a circulating equipment as shown in FIG. 1 so as to be supplied to a nozzle 2 by a circulating pump 3. A semiconductor substrate 4 was sprayed with a washing liquid and washed. Thereafter, the washing liquid was returned into the chemical solution tank through a recovery drain 5. The circulating pump was continuously operated and pH of the washing liquid in the chemical solution tank was measured with time. Also, the same test was performed also with regard to Washing Liquid 3. The results are shown together in Table 2.

TABLE 3

| | Washing | Washing |
|---|---|---|
| | Liquid 2 | Liquid 3 |
| Ammonium Oxalate (wt %) | 0.1 | 0.1 |
| HEDP*1 (wt %) | 0.01 | 0.01 |
| Ammonium Hydroxide (wt %) | 0.015 | 0.015 |
| Ammonium Fluoride (wt %) | 0.38 | 0.38 |
| Ammonium Carbonate (wt %) | 0.2 | |
| Water (wt %) | 99.295 | 99.495 |
| temperature of washing liquid (° C.) | 25 | 25 |
| pH immediately | 8.2 | 8.2 |
| after circulating | | |
| pH at 24-hour standing | 8.0 | 7.5 |
| after circulating | | |
| pH at 48-hour standing | 7.7 | 6.6 |
| after circulating | | |

*11-hydroxyethylidene-1,1-diphosphonic acid

In the circulating use of a washing liquid as Example 2, the washing liquid was sprayed from a nozzle, and thereby a part of components in the washing liquid is volatilized, so that the pH thereof easily fluctuates; however, ammonium carbonate is contained therein as a pH buffering solution, so as to control the change thereof, leading to an improvement in the stability of the washing liquid.

### Example 3

Washing Liquids 4 and 5 were prepared in accordance with composition described in Table 4. A semiconductor substrate on which a polysilicon film was formed was immersed in these washing liquids, and then the thickness of the polysilicon film was measured before and after being immersed, thereby measuring the etching rate. The results are shown in Table 4.

TABLE 4

| | Washing | Washing |
|---|---|---|
| | Liquid 4 | Liquid 5 |
| Ammonium Oxalate (wt %) | 0.1 | 0.1 |
| HEDP*1 (wt %) | 0.01 | 0.01 |
| Ammonium Hydroxide (wt %) | 0.015 | 0.015 |
| Ammonium Fluoride (wt %) | 0.38 | 0.38 |
| ADEKA TR-702* (wt %) | 0.2 | |
| Water (wt %) | 99.295 | 99.495 |
| pH of washing liquid | 8.1 | 8.2 |
| Washing Temperature (° C.) | 24 | 24 |
| Etching Rate of | <1.0 | 11.2 |
| Polysilicon Film (Å/min) | | |

*1: 1-hydroxyethylidene-1,1-diphosphonic acid
*ADEKA TR702: A compound represented in the formula (II) such that the average molecular weight of an oxypropylene group is 2500 to 3000, x/(x + y) = 0.2, R is >N—R²—N<, R² is ethylene, and m = 4

It is understood from Example 3 that a washing liquid containing a surfactant represented in the formula (II) suppresses the etching of a polysilicon film more than not comprising the same. It is therefrom understood that a washing liquid containing a surfactant represented in the formula (II) is more preferable for a substrate on whose surface a polysilicon film and the like is exposed.

According to the present invention, a superior washing liquid for a semiconductor substrate can be provided such as to be usable at the normal temperature and also not to cause etching and the like on a silicon oxide film and a metal film such as tungsten film while maintaining a superior removing performance of metallic ions and metallic impurities on the surface of a semiconductor substrate.

What is claimed is:

1. A washing liquid for a semiconductor substrate having a pH of 6 to 12 comprising:
a chelating agent; and
a chelate accelerating agent.

2. The washing liquid for a semiconductor substrate according to claim 1, wherein the chelating agent is at least one selected from the group consisting of heterocyclic compounds having at least one of a hydroxyl group and a carboxyl group, polyaminocarboxylic acids and a salt thereof, polycarboxylic acids and a salt thereof, compounds having a phosphonic group and a salt thereof, oxycarboxylic acids and a salt thereof, phenols and tropolones.

3. The washing liquid for a semiconductor substrate according to claim 2, wherein the chelating agent is at least one kind selected from the group consisting of ethylenediaminetetraacetic acid, oxalic acid, ammonium oxalate, 1-hydroxyethylidene-1,1-diphosphonic acid, citric acid, ammonium citrate, catechol, 8-quinolinol and tropolone.

4. The washing liquid for a semiconductor substrate according to claim 1, wherein the chelate accelerating agent comprises a compound having a hydroxyl group and at least one of a fluoride and a salt thereof.

5. The washing liquid for a semiconductor substrate according to claim 4, wherein the compound having a hydroxyl group is at least one selected from the group consisting of ammonium hydroxide, tetramethylammonium hydroxide and trimethyl(2-hydroxy)ethylammonium hydroxide.

6. The washing liquid for a semiconductor substrate according to claim 4, wherein the fluoride is hydrofluoric acid and the salt is ammonium fluoride.

7. The washing liquid for a semiconductor substrate according to claim 6, wherein the compound having a hydroxyl group is ammonium hydroxide, and at least one of the fluoride and the salt thereof is ammonium fluoride.

8. The washing liquid for a semiconductor substrate according to claim 1, further comprising a pH buffering agent.

9. The washing liquid for a semiconductor substrate according to claim 8, wherein the pH buffering agent is at least one selected from the group consisting of ammonium hydrogen phthalate, ammonium dihydrogen citrate, ammonium chloride, ammonium citrate, ammonium hydrogen carbonate, ammonium carbonate and ammonium acetate.

10. The washing liquid for a semiconductor substrate according to claim 1, further comprising at least one of surfactants represented in the following formula I or formula II.
HO—((EO)ₓ(PO)_{y})—H (I)
(EO denotes an oxyethylene group, PO denotes an oxypropylene group, x and y denote a positive number satisfying x/(x+y)=0.05 to 0.4, and z denotes a positive integer.)
R—[((EO)ₓ—(PO)_{y})_{z}—H]ₘ (II)
(EO denotes an oxyethylene group, PO denotes an oxypropylene group, x and y denote a positive number satisfying x/(x+y)=0.05 to 0.4, z denotes a positive integer, R denotes a monovalent group represented in R¹—O—, H₂N—R²—NH— and H₂N—R³—O—, a divalent group represented in H₂N—R²—N<, —HN—R³—O— and —NH—R³—NH—, a trivalent group represented in —HN—R²—N< and >N—R³—O—, or a tetravalent group represented in >N—R²—N<, and m denotes an integer of 1 to 4 corresponding to a valence number of R. R¹ denotes an alkyl group with a carbon number of 1 to 20, and R² and R³ denote each independently an alkylene group with a carbon number of 1 to 10.)

11. A method of washing a semiconductor substrate comprising the step of washing a semiconductor substrate with a use of the washing liquid for a semiconductor substrate according to claim 1.
